(19) United States
(12) Patent Application Publication
(10) Pub. No.: US 2003/0169764 A1
(43) Pub. Date: Sep. 11, 2003

(54) Network device for sampling a packet

(76) Inventors: Bruce E. Lavigne, Roseville, CA (US); Michael S. Vacanti, Roseville, CA (US)

Correspondence Address: HEWLETT-PACKARD COMPANY, Intellectual Property Administration, P.O. Box 272400, Fort Collins, CO, 80527-2400, US

(21) Appl. No.: 10/091,694

(22) Filed: Mar. 5, 2002

(51) Int. Cl. H04L 12/66

(52) U.S. Cl. 370/463

(57) ABSTRACT

A network device for sampling a packet. The network device comprises a processor. The network device also comprises an input interface for receiving a plurality of packets, wherein the input interface comprises at least one input port. At least one input port is configured to sample at least one input packet and transmit a sampled input packet to the processor. The network device also comprises an output interface for transmitting a plurality of packets, wherein the output interface comprises at least one output port. At least one output port is configured to sample at least one output packet and transmit a sampled output packet to the processor. The network device also comprises a switching fabric coupled to the input interface and the output interface, wherein the switching fabric is configured to transmit a packet between the input interface and the output interface.

### FIELD OF INVENTION

Embodiments of the present invention relate to the field of computer networking.

### BACKGROUND OF THE INVENTION

Computer networks are used to facilitate the movement of information from one computer system to another. Routers and switches, which transfer data among various networks or over the Internet, are the backbone of networking technology.

Innovations in computer networking technology are progressing at a fast rate. Data transfer speeds that once were considered extremely fast are now considered out of date. High speed networks are used in many situations, both home and business, for access to the Internet. As the bandwidth potential of computer networks grow, through advances such as fiber optic networks, the traffic transmitted across networks grows as well. The increase in traffic often causes network congestion, resulting in the dropping of packets and the backing off of transfer rates.

In order to ensure efficient use of network resources, it is desirable to monitor the network to provide a network administrator with information regarding network traffic flow. Specifically, in order to better distribute network resources, a network administrator requires information regarding the traffic at particular nodes (e.g., switches and routers) of the network. This information assists the network administrator in determining how to reconfigure the network to better allocate resources and where the network needs to grow to accommodate increased traffic flow.

Due to the high amount of network traffic, it is not desirable to perform an analysis of all data packets transferred over a network to understand the traffic flow. However, one way to monitor network traffic flow is to perform a statistical analysis on a sample of data packets. Sampling is the analysis of network traffic by determining the characteristics of a percentage of data packets chosen at random.

Currently, data packets of network traffic are randomly sampled only at the inbound side of a switch. A sampled data packet is sent to a central processing unit (CPU) of the switch for processing. The CPU then determines which port the data packet was received at, which port the data packet would have been sent out from, and whether the packet should be considered an inbound or outbound sample. The CPU then forwards the data packet with the port information to a statistical monitoring station over the network. The processing performed by the CPU consumes a large amount of the CPU's bandwidth.

A statistical monitoring station is a computer system accessed by the network administrator that performs a statistical analysis on sampled data packets to determine what the network traffic looks like. Typically, the statistical monitoring station requires approximately one packet per second. If all ports receive data packets at the same speed, the sampling is easy to accomplish.

However, typically there are multiple ports receiving data packets at many different speeds. For example, consider the situation where one port receives data packets at the speed of 10 megabits per second. In order to sample data packets at approximately one packet per second, approximately one data packet out of every 14,000 is sampled. If another port receives data packets at the rate of 1 gigabit per second, and one data packet out of every 14,000 is sampled, then 100 data packets are sampled per second.

Therefore, there exist numerous problems associated with prior art sampling schemes and techniques. First, as shown in the example above, many more packets are sampled than are desired by the statistical monitoring station. This results in over-sampling, and may reduce the accuracy and efficiency of network traffic sampling. Furthermore, every packet sampled on the inbound side must be processed by the CPU prior to transmitting the sampled data packet to the statistical monitoring station. Processing the extra data packets is very computer intensive, and can create a bottleneck in the sampling of data packets by consuming a significant portion of the CPU's bandwidth.

### SUMMARY OF THE INVENTION

A network device for sampling a packet is described. An input interface receives a number of packets. The input interface has at least one input port. At least one input port is configured to sample a packet and transmit a sampled input packet a processor of the network device. The network device also includes an output interface for transmitting a plurality of packets. Likewise, the output interface has at least one output port. One of the output ports is configured to sample at least one output packet and transmit a sampled output packet to the processor. The network device also incorporates a switching fabric coupled to the input interface and the output interface. This switching fabric is configured to transmit a packet between the input interface and the output interface.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 illustrates steps in a process of sampling a packet in accordance with one embodiment of the present invention.

FIG. 2 illustrates a block diagram of an exemplary interface for sampling packets in accordance with one embodiment of the present invention.

FIG. 3 illustrates a block diagram of elements of an exemplary network switch upon which embodiments of the present invention may be practiced.

### BEST MODE(S) FOR CARRYING OUT THE INVENTION

A network device for sampling a packet. The network device comprises a processor. The network device also comprises an input interface for receiving a plurality of packets, wherein the input interface comprises at least one input port. At least one input port is configured to sample at least one input packet and transmit a sampled input packet to the processor. The network device also comprises an output interface for transmitting a plurality of packets, wherein the output interface comprises at least one output port. At least one output port is configured to sample at least one output packet and transmit a sampled output packet to the processor. The network device also comprises a switching fabric coupled to the input interface and the output interface, wherein the switching fabric is configured to transmit a packet between the input interface and the output interface.

An embodiment of the present invention provides a device and method for sampling a packet that reduces the number of sampled packets forwarded for processing, thus allowing the processor to perform other tasks. Furthermore, the embodiments of the present invention provide a device and method for sampling a packet at an outbound port, requiring less processing per packet. As a beneficial result, network routers or switches utilizing embodiments of the present invention require less processing overhead in sampling packets for maintaining network statistical counters. Additionally, embodiments of the present invention may be practiced with little or no additional hardware cost over the prior art.

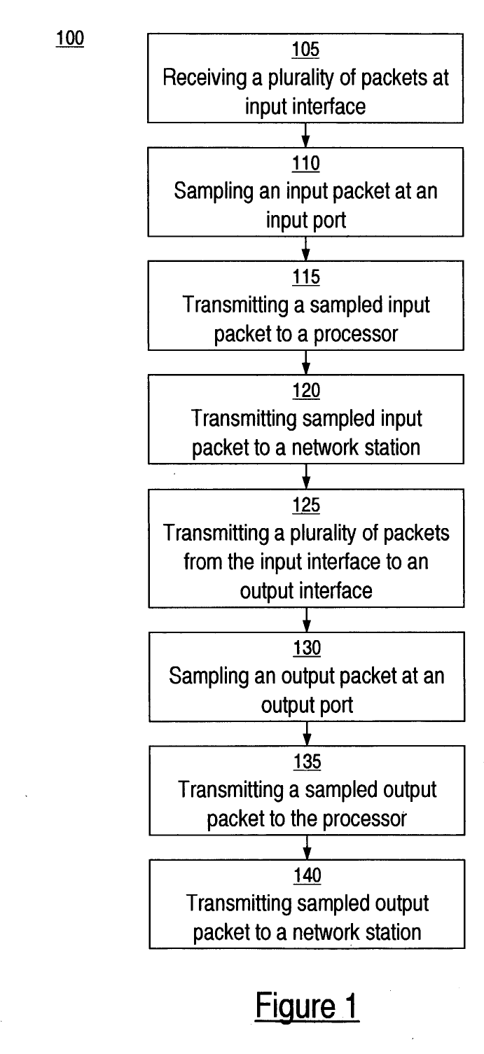

FIG. 1 illustrates steps in a process 100 of sampling a packet in accordance with one embodiment of the present invention. In one embodiment, process 100 is carried out by processors and electrical components under the control of computer readable and computer executable instructions. The computer readable and computer executable instructions reside, for example, in data storage features such as a computer usable volatile memory and/or computer usable non-volatile memory. However, the computer readable and computer executable instructions may reside in any type of computer readable medium. Although specific steps are disclosed in process 100, such steps are exemplary. That is, the embodiments of the present invention are well suited to performing various other steps or variations of the steps recited in FIG. 1.

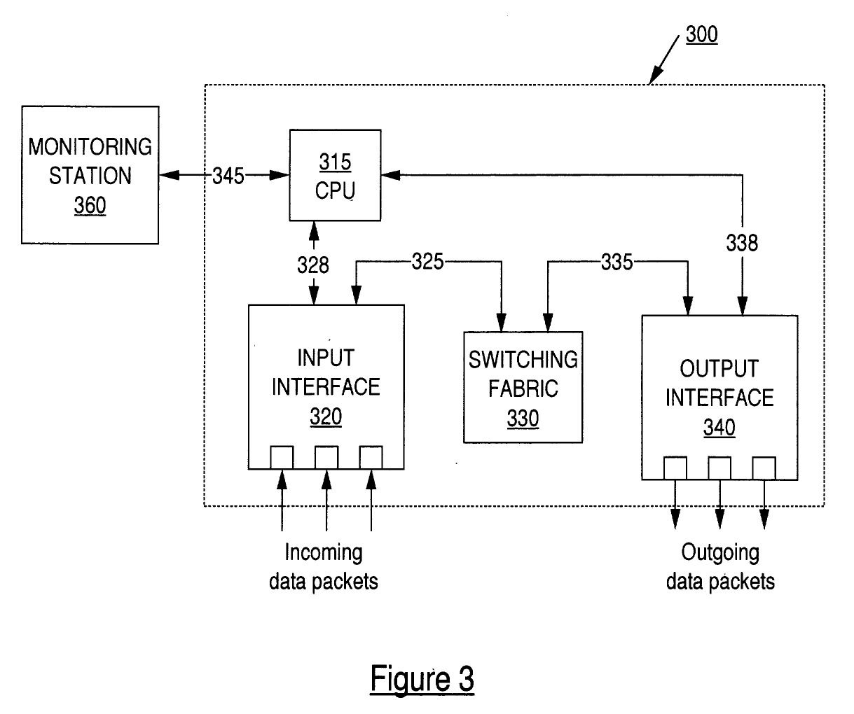

At step 105 of process 100, a plurality of data packets are received at an input interface (e.g., input interface 320 of FIG. 3). In one embodiment, the input interface comprises at least one input port. In one embodiment, the plurality of data packets is comprised of Internet protocol (IP) packets.

At step 110, an incoming packet is sampled at an input port. In one embodiment, at least one input port comprises a countdown register. In one embodiment, the countdown register is a random number countdown register. The countdown register operates by counting incoming packets and, upon completing the countdown, sampling an incoming packet. The countdown register then restarts counting down through incoming packets until the next sampling is performed. In one embodiment, the random number countdown register counts down from a random number, thereby giving an improved statistical sampling.

At step 115, at least one sampled incoming packet is transmitted to a processor. In one embodiment, the sampled incoming packet includes information regarding the identification of the input port that sampled the particular sampled incoming packet.

At step 120, the processor transmits the sampled incoming packet to a network station over a network. In one embodiment, the network station is a central control station. In another embodiment, the network station is a statistical monitoring station for monitoring network traffic.

At step 125, a plurality of packets is transmitted from the input interface to an output interface (e.g., output interface 340 of FIG. 3) over a switching fabric. In one embodiment, the output interface comprises at least one output port and a processor.

At step 130, an outgoing packet is sampled at an output port. In one embodiment, at least one output port comprises a countdown register. In one embodiment, the countdown register is a random number countdown register. The countdown register operates by counting outgoing packets and, upon completing the countdown, sampling an outgoing packet. The countdown register then restarts counting down through outgoing packets until the next sampling is performed. In one embodiment, the random number countdown register counts down from a random number, thereby giving an improved statistical sampling.

It should be appreciated that sampled output packets may be sampled from multiple output ports within an output interface simultaneously, as in the case of a multicast or broadcast packet which causes multiple ports to decrement their respective countdown registers to zero at once. Multiple sampled outgoing packets which where sampled simultaneously may be sent to one or more processors. In one embodiment, one sampled outgoing packet per output interface is transmitted to the processor, wherein the sampled outgoing packet comprises a bitmask of which output ports were sampled.

At step 135, at least one sampled outgoing packet is transmitted to the processor. In one embodiment, the sampled outgoing packet includes information regarding the identification of the output port that sampled the particular sampled outgoing packet.

At step 140, the processor transmits the sampled outgoing packet to a network station over a network. In one embodiment, the network station is a central control station. In another embodiment, the network station is a statistical monitoring station for monitoring network traffic.

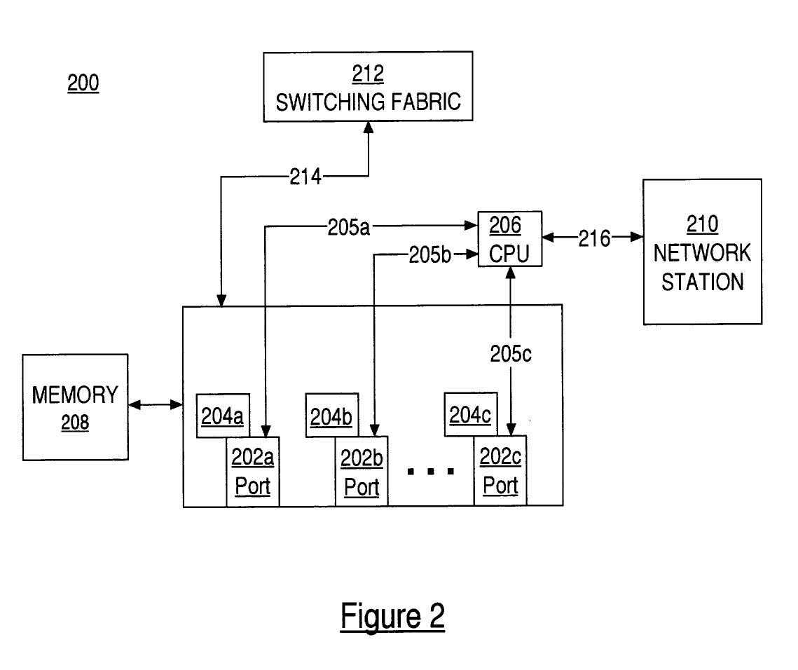

FIG. 2 illustrates a block diagram of an exemplary interface 200 for sampling packets in accordance with one embodiment of the present invention. In one embodiment, interface 200 is a packet processor.

In one embodiment, interface 200 comprises at least one port (e.g., ports 202a-c). It should be appreciated that interface 200 can have any number of ports, and is not limited to the embodiment illustrated in FIG. 2. Ports 202a-c provide a physical interface to a communications link. In one embodiment, the communications link is a network, or segment of a network, comprising, for example, FDDI, fiber optic token ring, T1, Bluetooth, 802.11, Ethernet etc. The network may be a portion of a LAN, MAN, WAN or other networking arrangement.

At least one port 202 of interface 200 comprises a countdown register 204 (e.g., countdown circuit). It should be appreciated that any number of ports 202a-c comprises a countdown register 204a-c. In one embodiment, the countdown register is a random number countdown register. The countdown register operates by counting packets and, upon completing the countdown, sampling a packet. The countdown register then restarts counting down through packets until the next sampling is performed. In one embodiment, the random number countdown register counts down from a random number, thereby giving an improved statistical sampling.

Interface 200 also comprises a processor 206. In one embodiment, processor 206 is a microcontroller. In another embodiment, processor 206 is a central processing unit (CPU). In one embodiment, processor 206 receives sampled packets from ports 202a-c over connections 205a-c, respectively. It should be appreciated that a plurality of interfaces can share a single processor. In one embodiment, there is one processor shared by a set of interfaces, wherein the set comprises one input interface and one output interface. In one embodiment, where a packet is travelling from an input interface to an output interface within the same set, both the sampled input packet and the sampled output packet are directed at the same processor. In another embodiment, where a packet is travelling from an input interface to an output interface not within the same set, the sampled input packet and the sampled output packet are directed at separate processors.

In one embodiment, processor 206 transmits sampled packets to network station 210 over network connection 216. In one embodiment, network station 210 is a central control station. In another embodiment, network station 210 is a statistical monitoring station for monitoring network traffic.

Interface 200 also comprises an associated memory 208 for storing many types of information, including packets received or to be transmitted over ports 202a-c. It is to be appreciated that memory 208 may be internal or external to interface 200 in accordance with embodiments of the present invention. In one embodiment, interface 200 is configured to receive packets over ports 202. In another embodiment, interface 200 is configured to transmit packets over ports 202.

In one embodiment, interface 200 may have a local connection 214 to switching fabric 212. In one embodiment, switching fabric 212 is configured to communicatively couple interface 200 with another interface. For example, where interface 200 is an input interface, it may be communicatively coupled to an outgoing interface through switching fabric 212. It is appreciated that switching fabric 212 may also interconnect with other interface, in accordance with embodiments of the present invention. Interfaces (e.g. input interface 320 and output interface 340 of FIG. 3) will generally contain a CPU or microcontroller to control their operation.

FIG. 3 illustrates a block diagram of elements of an exemplary network switch upon which embodiments of the present invention may be practiced. At a high level, network switch 300 comprises at least two interfaces (e.g., interface 200 of FIG. 2), for example input interface 320 and output interface 340, a CPU 315, and a switching fabric, e.g., switching fabric 330, which allows input interface 320 and output interface 340 to communicate with each other. It should be appreciated that switch 300 may include any number of similar input or output interfaces. In one embodiment, network switch 300 is an application specific integrated circuit (ASIC).

Input interface 320 (e.g., an input network circuit) comprises at least one input port 310. In one embodiment, input interface 320 is configured to receive a plurality of packets. At least one port 310 is configured to sample at least one input packet and transmit a sampled input packet to CPU 315 over connection 328. CPU 315 is configured to transmit the sampled input packet to monitoring station 360 over connection 345. In one embodiment, monitoring station 360 is a network station. In another embodiment, the monitoring station 360 is a central control station. In another embodiment, the monitoring station 360 is a statistical monitoring station for monitoring network traffic. In one embodiment, connection 345 is a network connection.

Input interface 320 is communicatively coupled to switching fabric 330 over connection 325. In one embodiment, connection 325 is a local connection. In the present embodiment, switching fabric 330 is communicatively coupling input interface 320, via connection 325, with output interface 340, via connection 335. It is appreciated that switching fabric 330 may also interconnect with other interfaces (e.g., interface 200 of FIG. 2) in accordance with embodiments of the present invention.

Output interface 340 (e.g., and output network circuit) comprises at least one output port 350. In one embodiment, output interface 340 is configured to receive a plurality of packets from switching fabric 330 via connection 335. At least one port 350 is configured to sample at least one output packet and transmit a sampled output packet to CPU 315 over connection 338. CPU 315 is configured to transmit the sampled output packet to monitoring station 360 over connection 345. In one embodiment, connection 345 is a network connection.

The various embodiments of a method and device for sampling a packet, are thus described. While the present invention has been described in particular embodiments, it should be appreciated that the present invention should not be construed as limited by such embodiments, but rather construed according to the below claims.

What is claimed is:

1. A network device comprising:
a processor;
an input interface for receiving a plurality of packets coupled to said processor, said input interface comprising at least one input port wherein at least one said input port is configured to sample at least one input packet and transmit a sampled input packet to said processor;
an output interface for transmitting a plurality of packets coupled to said processor, said output interface comprising at least one output port wherein at least one said output port is configured to sample at least one output packet and transmit a sampled output packet to said processor; and
a switching fabric coupled to said input interface and said output interface, said switching fabric configured to transmit a packet between said input interface and said output interface.

2. A network device as recited in claim 1 wherein at least one said input port comprises a countdown register, wherein said input port is configured to sample a packet according to said countdown register.

3. A network device as recited in claim 1 wherein at least one said output port comprises a countdown register, wherein said output port is configured to sample a packet according to said countdown register.

4. A network device as recited in claim 1 wherein said processor transmits said sampled input packet and said sampled output packet to a central control station over a network.

5. A network device as recited in claim 4 wherein said central control station comprises a statistical monitoring station.

6. A network device as recited in claim 1 wherein said sampled input packet comprises an identification of said input port that sampled said sampled input packet.

7. A network device as recited in claim 1 wherein said sampled output packet comprises an identification of said output port that sampled said sampled output packet.

8. A network device as recited in claim 2 wherein said countdown register is a random number countdown register.

9. A network device as recited in claim 3 wherein said countdown register is a random number countdown register.

10. A method of sampling a packet comprising:
a) receiving a plurality of packets at an input network circuit, said input network circuit comprising at least one input port;
b) sampling at least one input packet at said input port;
c) transmitting at least one sampled input packet to a processor;
d) transmitting at least on packet from said input network circuit to an output network circuit over a switching fabric, said output network circuit comprising at least one output port;
e) sampling at least one output packet at said output port; and
f) transmitting at least one sampled output packet to said processor.

11. A method as recited in claim 10 wherein said b) comprises sampling said input packet according to a countdown circuit.

12. A method as recited in claim 11 wherein said countdown circuit is a random number countdown circuit.

13. A method as recited in claim 10 wherein said e) comprises sampling said output packet according to a countdown circuit.

14. A method as recited in claim 13 wherein said countdown circuit is a random number countdown circuit.

15. A method as recited in claim 10 further comprising said processor transmitting said sampled input packet to a statistical monitoring station over a network.

16. A method as recited in claim 10 further comprising said processor transmitting said sampled output packet to a statistical monitoring station over a network.

17. A method as recited in claim 10 wherein said sampled input packet comprises information regarding said input port performing said b).

18. A method as recited in claim 10 wherein said sampled output packet comprises information regarding said output port performing said e).

19. A system for sampling a packet comprising:
processing means;
means for receiving a plurality of packets over a network, said means for receiving a plurality of packets comprising an input means for sampling at least one packet and transmitting a sampled incoming packet to said processing means, said means for receiving a plurality of packets coupled to said processing means;
means for transmitting a plurality of packets over said network, said means for transmitting a plurality of packets comprising an output means for sampling at least one packet and transmitting a sampled outgoing packet to said processing means, said means for transmitting a plurality of packets coupled to said processing means; and
switching means coupled to said means for receiving a plurality of packets and said means for transmitting a plurality of packets, said switching means for transmitting a packet between said means for receiving a plurality of packets and said means for transmitting a plurality of packets.

20. A system as recited in claim 19 wherein at least one said output means comprises a countdown means, wherein said output means is configured to sample a packet of said plurality of packets according to said countdown means.

21. A system as recited in claim 19 wherein at least one said input means comprises a countdown means, wherein said input means is configured to sample a packet of said plurality of packets according to said countdown means.

22. A system as recited in claim 19 wherein said processing means transmits said sampled incoming packet and said sampled outgoing packet to a central control means over a network.

23. A network device comprising:
a switching fabric;
an input interface coupled to said switching fabric, said input interface comprising at least one input port;
an output interface coupled to said switching fabric, said output interface comprising at least one output port;
a computer-readable memory coupled to said input interface and said output interface; and
a microcontroller coupled to said input interface and said output interface, said microcontroller for executing a method of sampling a packet, said method comprising:
a) sampling at least one incoming packet at received at said input port;
b) transmitting said sampled incoming packet to said microcontroller;
c) transmitting at least one packet from said input interface to said output interface over said switching fabric;
d) sampling at least one outgoing packet at said output port; and
e) transmitting said sampled outgoing packet to said microcontroller.

24. A network device as recited in claim 23 wherein said method further comprises said microcontroller transmitting said sampled incoming packet to a statistical monitoring station over a network.

25. A network device as recited in claim 23 wherein said method further comprises said microcontroller transmitting said sampled outgoing packet to a statistical monitoring station over a network.
